(19) United States
(12) Patent Application Publication
(10) Pub. No.: US 2006/0117323 A1
(43) Pub. Date: Jun. 1, 2006

(54) Method, system and computer program product for controlling objects on a computer system

(76) Inventor: Jerry T. Kendall, North York (CA)

Correspondence Address: BERESKIN AND PARR, 40 KING STREET WEST, BOX 401, TORONTO, ON, M5H 3Y2, CA

(21) Appl. No.: 10/989,380

(22) Filed: Nov. 17, 2004

(51) Int. Cl. G06F 9/44

(52) U.S. Cl. 719/315

(57) ABSTRACT

An object management module, method and computer software product for managing a plurality of objects stored on a computer network having a plurality of network components are provided. For each object in the plurality of objects, an associated object identifier is determined using all bytes in the object such that identical objects in the plurality of objects have the same associated object identifier. For each object in the plurality of objects, the associated object identifier is stored in an object store.

### FIELD OF THE INVENTION

The present invention relates generally to managing computer networks, and more particularly relates to managing a plurality of objects, such as, for example, images, documents or executable programs, stored on a plurality of network components in a computer network, each network component having a storage capacity for storing objects.

### BACKGROUND OF THE INVENTION

Computer networks typically comprise many different network components, such as, for example, workstations, routers/switches, printers and servers, as well as the software installed on these network components. The number, size and complexity of these computer networks are growing. This growth is spurred by a number of factors. First, the development of wireless technology has made mobile workstations that are connected to computer networks possible. Further, with the rise of telecommuting, and having computer networks span many different offices in different cities, different countries, and possibly on different continents, the distances spanned by a particular computer network are increasing. Finally, an increasingly diverse assortment of software may be installed on different network components, greatly increasing both the functionality and complexity of computer networks.

All of this growth places an increasing burden on the resources dedicated to supporting computer networks. For example, while local bandwidth may be relatively inexpensive, the same cannot be said for bandwidth over large distances. Thus, if a considerable amount of information has to be sent frequently between different network components in the same computer network but in different locations separated by great distances, then this will place a burden on existing communication infrastructure. Further, the transmission of information will, in some cases, be very slow, slowing down the efficiency of the network, and placing a burden on the technical support personnel whose job it is to keep the network fully operational.

The demands placed on these technical support personnel also grow as a result of the increase in both the number of programs installed on network components such as servers and workstations and the number of these network components within the computer network. This situation is exacerbated by the fact that different network components may have different requirements—for example, workstations that require wireless connections may have, in some cases, different requirements than those that rely on wire connections. Accordingly, more efficient ways of managing computer networks are required.

### SUMMARY OF THE INVENTION

According to an aspect of the present invention, a unique digital signature object identification process is used to (1) uniquely identify all objects, regardless of the type of object (ie. images, documents, executable programs, etc.), and/or the electronic device on which they are stored (ie. a computer, personal digital assistant, cell phone or other network device, such as routers, hubs and switches); and (2) determine, based on a set of rules and conditions contained in a database, actions to perform with respect to each of these objects (ie. deletion, creation, modification, etc.).

Aspects of the present invention may be used to manage computing devices and the network connections between these devices, whether wired or wireless. This management could be from a single point or workstation where the operator would select specified actions to be performed on selected computing and network devices on a scheduled basis. For example, an operator might wish to make regular nightly backups of a group of computers located in a business critical data center.

In accordance with an aspect of the invention, there is provided an object management module for installation in a computer network having a plurality of network components, the plurality of network components being electronically connected for communication therebetween, and having a plurality of objects stored thereon. The object management module comprises (a) an object selector for locating each object in the plurality of objects; (b) an object identification means for, for each object in the plurality of objects, determining an associated object identifier from all bytes in the object such that identical objects in the plurality of objects have the same associated object identifier; and, (c) an object storage manager for, for each object in the plurality of objects, storing the associated object identifier in an object store.

In accordance with a second aspect of the invention, there is provided a method of managing a plurality of objects stored on a computer network having a plurality of network components. The method comprises (a) for each object in the plurality of objects, determining an associated object identifier using all bytes in the object such that identical objects in the plurality of objects have the same associated object identifier; and, (b) for each object in the plurality of objects, storing the associated object identifier in an object store.

In accordance with a third aspect of the invention, there is provided a computer program product for use on a computer network having a plurality of network components to manage a plurality of objects stored on the computer network. The computer program product comprises a recording medium; and, means recorded on the recording medium for instructing the computer system to perform the steps of: (a) for each object in the plurality of objects, determining an associated object identifier using all bytes in the object such that identical objects in the plurality of objects have the same associated object identifier; and, (b) for each object in the plurality of objects, storing the associated object identifier in an object store.

### BRIEF DESCRIPTION OF THE DRAWINGS

A detailed description of preferred aspects of the invention is provided herein below, with reference to the following drawings, in which

FIG. 1, in a block diagram, illustrates a computer network in accordance with an aspect of the present invention;

FIG. 2, in a block diagram, illustrates an object management module of the computer network of FIG. 1;

FIG. 3, in a block diagram, illustrates a record stored in an object store of the object management module of FIG. 2;

FIG. 4, in a block diagram, illustrates an object processor of the object management module of FIG. 2;

FIG. 5, in a flowchart, illustrates a method of storing information regarding a plurality of objects stored on the computer network of FIG. 1 in the object store of the object management module of FIG. 2;

FIG. 6, in a flowchart, illustrates a method of processing objects in a plurality of objects stored on the computer network of FIG. 1; and

FIG. 7, in a process flow diagram, illustrates the workings of the object management module of FIG. 2.

### DETAILED DESCRIPTION OF PREFERRED ASPECTS OF THE INVENTION

As described above, computer networks may include a very large number of network components, which may be separated from each other by considerable distances. Further, many different individual objects, such as executable programs, may be stored on the individual workstations or other network components. However, in order to provide similar functionality to each network component and to allow different network components to interact, many of the objects stored on one network component will also be stored on other network components.

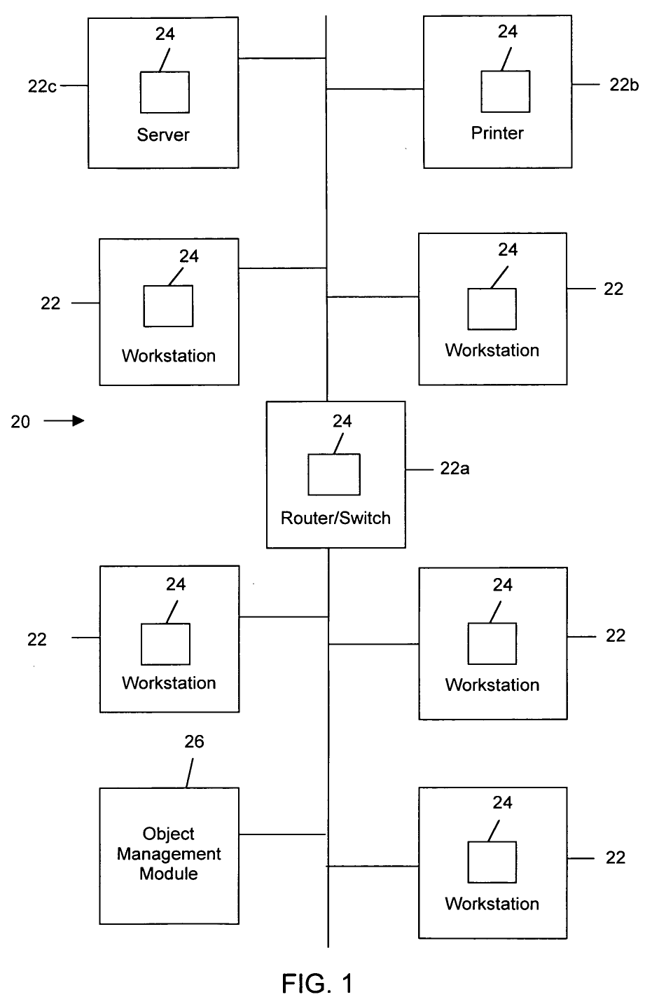

Referring to FIG. 1, there is illustrated in a block diagram a computer network 20 in accordance with an aspect of the invention. The computer network 20 comprises a plurality of network components including a plurality of individual computer workstations 22 as well as a router/switch 22a, printer 22b and server 22c (of course, an actual computer network might include more than one router/switch 22a, printer 22b or server 22c, or, alternatively, might not include any of these elements). Each of these individual network components comprises a memory 24 on which at least some objects in a plurality of objects are stored. The objects are typically computer/electronic files. Computer/electronic files are units of data storage contained in electronic form representing, for example:

(1) executable instructions to be performed by a computing device (for example, program, scripts, or processing instructions);

(2) information pertaining to, or assisting in, the execution of executable instructions (for example, configuration files, startup files, or temporary files);

(3) information to be processed, used, or manipulated by electronic means (databases, data files, record files, log files, or image files); or

(4) information pertaining to, or describing, a human readable equivalent (for example, documents, manuals, letters, faxes, or memos).

Although the computer network 20 shown in FIG. 1 is a wired network, optionally, the invention may be implemented with respect to computer networks that are fully or partially wireless (for example, PDA's or cellular phones).

As described above, these objects may be, for example, images, documents, executable programs or other files. Although the computer network 20 shown in FIG. 1 is a wired network, optionally, the invention may be implemented with respect to computer networks that are fully or partially wireless (for example, PDA's or cellular phones).

As shown in FIG. 1, computer network 20 also comprises an object management module 26 for managing the plurality of objects stored throughout the computer network 20. This object management module 26 may be a single device, such as an individual workstation, or may be spread throughout a plurality of different devices. For example, the object management module might comprise a plurality of different storage devices separated one from the other. Preferably, however, the object management module can be operated from a single location.

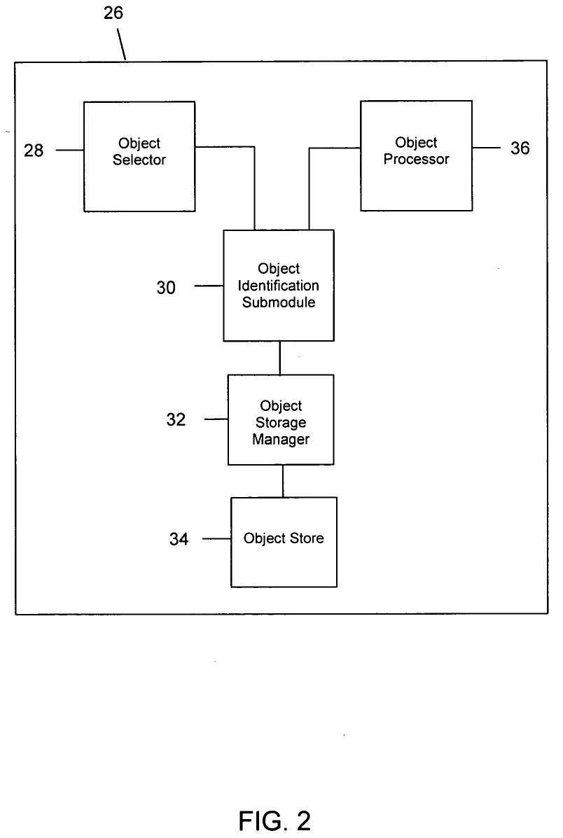

Referring to FIG. 2, the object management module 26 of FIG. 1 is illustrated in a block diagram in more detail. As shown in FIG. 2, object management module 26 comprises an object selector 28, an object identification submodule 30, an object storage manager 32, an object store 34 and an object processor 36. Each of these elements is considered in turn below.

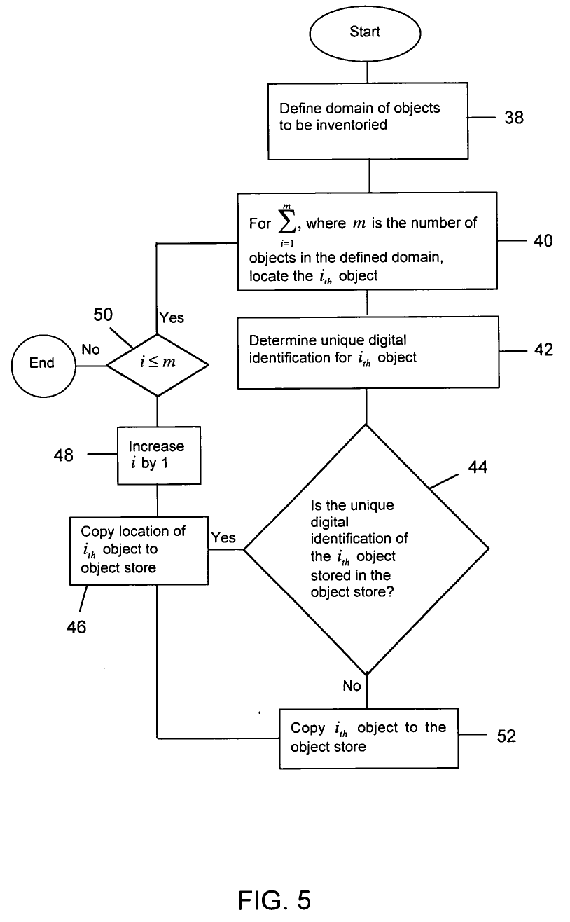

The object selector 28 is operable to locate each object in the plurality of objects stored on the computer network 20. The process according to which the object selector 28 operates is illustrated in the flowchart of FIG. 5. First, in step 38 of the method of FIG. 5, a domain of objects in the plurality objects to be inventoried is defined. For example, the defined domain may be all executable programs, or, instead, all executable windows programs. Usually, such programs can be identified using the first part of path at which such programs are located—for example, the string c:/win/, in the case of windows programs. In step 40 of the method of FIG. 5, the object selector 28 locates a particular object in a particular network component such as a workstation 22 in the computer network 20. That is, say that there are some number, m, versions of Microsoft Internet Explorer™ stored on individual workstations. For example, say that there are 100 workstations, each of which has one version of Microsoft Internet Explorer™ stored thereon. Then, if the domain of objects to be inventoried is defined to be Microsoft Internet Explorer™, m=100, and in step 40, the object selector 28 will locate one version of Microsoft Internet Explorer™ on one computer workstation.

Once an individual object has been located, the presence of this object is reported to object identification submodule 30. In step 42 of the method of FIG. 5, the object identification submodule 30 determines a unique digital identification for the iₜₕ object being considered. This unique digital identification is derived from all of the bytes of the object and is communicated to the object storage manager 32, which, in query 44 of the flowchart of FIG. 5 checks the objects store 34 to determine whether the unique digital identification of this object has already been stored in the object store. If the unique digital identification for this particular object is already stored in the object store 34, then the method of FIG. 5 proceeds to step 46. In step 46, the location of the iₜₕ object is stored in the object store, and is linked to the copy of the object and the unique digital identification for that object that were previously stored in the object store, such that the object store manager 32 can subsequently determine from the object store 34 the locations at which all instances of a particular object are stored. After step 46, the method of FIG. 5 proceeds to step 48 in which the counter, i, is increased by 1. Then, query 50 checks whether there are still objects within the defined domain to be inventoried. If not, then query 50 returns the answer NO and the method of FIG. 5 ends. If there remain objects in the defined domain, then query 50 returns the answer YES and the method goes back to step 40 where the next object is considered.

If query 44 returns the answer NO, in that the unique digital identification for the iₜₕ object is not found in the object store 34, then the method of FIG. 5 proceeds to step 52 in which this object, together with its unique digital identification in the computer network 20, is copied to the object store 34 in step 52, before the method proceeds to step 46. In step 46, the location of the iₜₕ object is recorded in the object store, and is linked to the copy of the object and the unique digital identification for that object that were previously stored in the object store in step 52, such that the object store manager 32 can subsequently determine from the object store 34 the locations at which all instances of a particular object are stored.

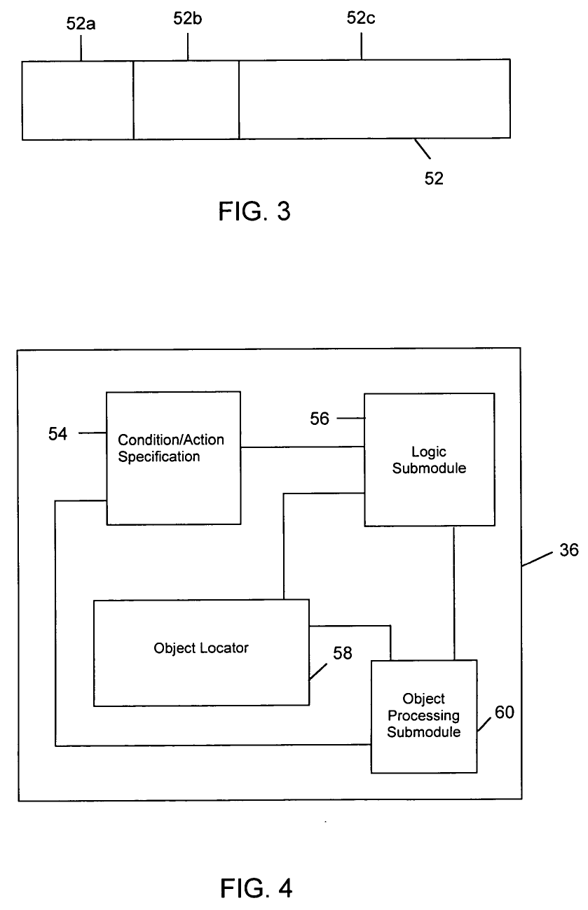

Within object store 34, all information regarding a single object is stored within a particular record structure. Referring to FIG. 3, record structure 52 comprises object storage field 52a for storing an object, object identification storage field 52b for storing the unique digital identification for this object, and location fields 52c for storing all of the locations within the computer network 20 at which instances of the object stored in 52a are stored.

Optionally, object management module 26 may be preprogrammed to inventory different domains of objects at different time intervals, such that the object store 34 is kept up-to-date.

Referring back to FIG. 2, object selector 28 and object processor 36 perform parallel, albeit different, functions. Optionally, these two submodules of object management module 26 may be combined in a single submodule. Referring to FIG. 4, object processor 36 is illustrated in more detail. However, those of skill in the art will appreciate that object selector 28 will preferably have elements analogous to those of object processor 36 to enable object selector 28 to perform its parallel functions.

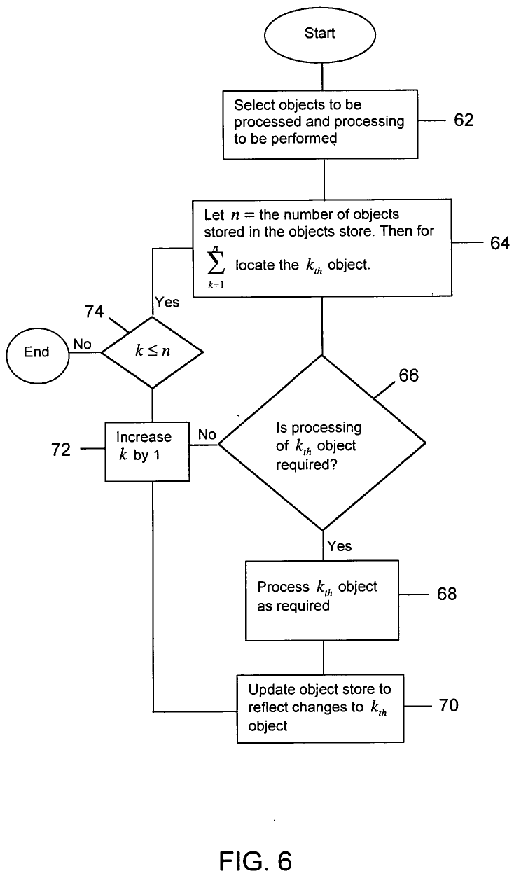

Referring to FIG. 4, object processor 36 is illustrated in more detail in a block diagram. That is, as shown in FIG. 4, object processor 36 comprises a condition/action specification 54, a logic submodule 56, an object locator 58 and an object processing submodule 60. The steps undertaken by object processor 36 are illustrated in the flowchart of FIG. 6. First, in step 62 of the method of FIG. 6, the objects to be processed, as well as the processing to be performed, are selected and defined respectively. The objects to be processed are selected by entering conditions into condition/action specification 54, which conditions identify these objects, while the processing to be performed on these objects is defined by inserting the corresponding actions into condition/action specification 54. Say that there are some number, n, objects stored in the objects store 34. Then, in step 64, the record structure 52 for a particular kₜₕ object in these n objects is located. The method then proceeds to query 66 in which logic submodule 56 of object processor 36 checks whether processing of this kₜₕ object is required. Whether processing of the iₜₕ object is required is determined by comparing the information stored in fields 52b and 52c in the record for the kₜₕ object with the conditions added to condition/action specification 54 in step 62 of the method of FIG. 6. For example, an action to be performed by object processor 36 might be conditional on the particular object, as in the case where a particular object is to be deleted from the computer network 20 and replaced with an updated version. In this case logic submodule 56 of object processor 36 will check only field 52b for the record for the kₜₕ object before taking any action. Alternatively, action by the object processor 36 may be conditional on both the identity and location of an object, in which case logic submodule 56 of object processor 36 will check both field 52b and field 52c of the record for the kₜₕ object against the conditions stored in condition/action specification 54 before taking any action.

If the object located in step 64 by object locator 58 is determined by logic submodule 56 to meet the conditions specified in condition/action specification 54, then, in step 68 of the method of FIG. 6, object processing submodule 60 processes the kₜₕ object in accordance with the action specified in the condition/action specification 54. Then, the method of FIG. 6 proceeds to step 70 in which the object processing submodule 60 updates the record for the kₜₕ object in the object store 34 to reflect the changes made to the object. The method then proceeds to step 72 where logic submodule 56 increases k by one. The method would have proceeded directly to step 72 if in query 66, logic submodule 56 had returned the answer NO, as the kₜₕ object located by the object locator 58 did not meet the conditions specified in condition/action specification 54. After step 72, the method of FIG. 6 proceeds to query 74, in which logic submodule 56 checks whether there remain objects in the object store to be considered vis-á-vis a particular set of processing requirements. If NO, then the method ends. If YES, then the method returns to step 64 in which the record structure 52 corresponding to the next object is located within the object store 34 by object locator 58.

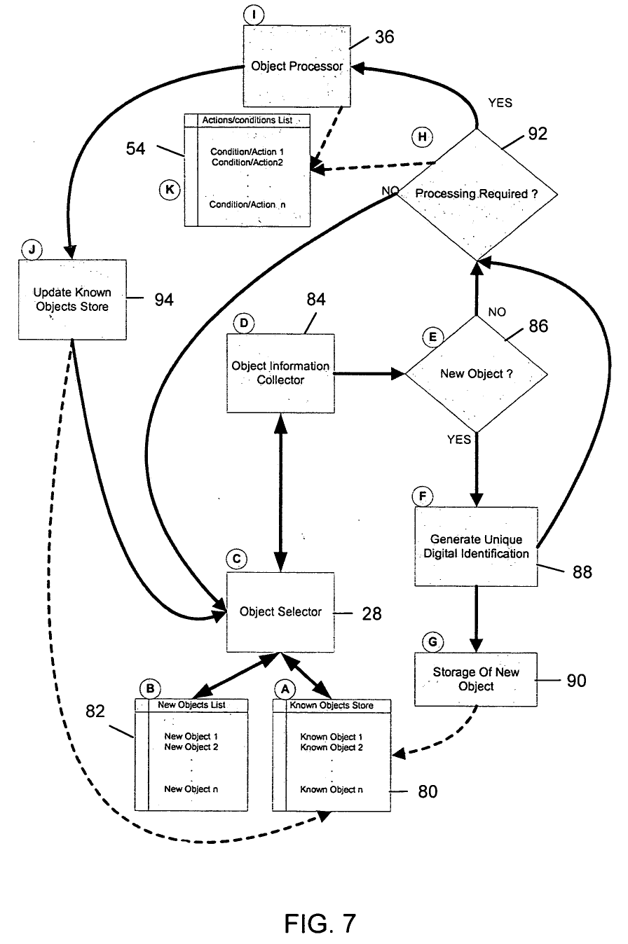

Referring to FIG. 7, various process flow points of the object management module 26 are illustrated in a process flow diagram. As illustrated, object store 34 comprises a known objects store 80 and a new objects list 82. Known objects store 80 stores all currently known objects, their digital identification, and the network components they are located on within the computer network 20. In addition to the actual object which is stored, known objects store 80 preferably stores many attributes of each object. For example, the location or full path to each instance of the actual object within the computer network 20, the size of the object (if applicable), when the object was created, when it was last accessed, when it was last modified, device information (if applicable) and access permissions for getting access to or changing the object.

As shown in FIG. 7, known objects store 80 can be accessed by object selector 28. Object selector 28 may do so using the digital identification for an object stored on the objects store 80, or by identifying a particular network component. In addition, in the case of some objects, it may be necessary to obtain permission before accessing the known objects store 80. In these cases, a user must demonstrate to the object store manager 32 that the user is authorized to access or change the particular object stored in the known objects store 80.

Say that object selector 28 locates an object, and that the digital identification for this object is not stored in the object store. Then, all of the attributes described above in connection with known objects store 80 are determined as required and then stored in new objects list 82.

After object selector 28 has finished conducting an inventory of a defined domain of objects within the computer network 20 as described above in connection with a method of FIG. 5, the object selector 28 collects object entries from the known objects store 80 at object information collector process point 84. After all of the entries within the known objects store 80 have been collected, object selector 28 retrieves all of the object entries from the new object list 82.

At process point 86, a logic submodule within object selector 28 checks whether object information collected at object information collector process point 84 is for a new object or not (that is, whether this information was retrieved from the new objects list 82 or the known objects store 80). If the object information is for a new object, then, at process point 88, the logic submodule of object selector 28 generates a unique digital identification at process point 88. This unique digital identification is generated using the object information obtained from the new objects list 82. Specifically, it is generated using each byte in the object. For example, the unique digital identification may be determined using secure hash algorithms, such as, for example, that defined by the secure hash standard outlined in Federal Information Processing Standards Publications (FIPS PUBS) as issued by the (U.S.) National Institute of Standards & Technology (NIST) after approval by the Secretary of Commerce pursuant to Section 5131 of Information Technology Management Reform Act of 1996 (Public Well 104-106, and the Computer Security Act of 1987 (Public Well 100-235). The Federal Information Processing Standard's website is located at http.//www.itl.nist.gov/fipspubs/index.htm.

The unique digital identification generated at process point 88 provides a unique digital fingerprint for the object in question. Once this unique digital fingerprint has been generated, the object and its attributes, including the unique digital identification just generated, are stored in the known objects store 80 at process point 90. This object information stored in the known objects store 80 will subsequently be collected at process point 84 and considered by the logic submodule within object selector 28 at process point 86 to determine whether the object information regards a new object. At that point, the object module for the object selector 28 will return the answer NO, as this object information was collected from the known objects store 80.

If the logic module for the object selector 28 returns the answer NO at process point 86, indicating that the object information is in the known objects store 80, then at process point 92, the logic submodule 58 of the object processor 36 checks this object information against the conditions stored in condition/action specification 54. If logic submodule 56 determines that no processing is required at process point 92, then no further action is taken at that time with respect to that particular object. If, on the other hand, logic submodule 56 at process point 92 compares the object information with the conditions stored in condition/action specification 54 and determines that the object information meets specified conditions stored there, then the object processing submodule 60 of object processor 36 processes the object according to the action specified in the condition/action specification 54 whose antecedent conditions are satisfied.

Any number of different actions may be specified with respect to particular objects. For example, the conditions stored in the condition/action specification 54 may include the unique digital identification for objects known to include malicious code, such as computer viruses. In that case, the corresponding actions stored in the condition/action specification 54 might well be to remove the object from all locations where it is found within the computer network 20. It would, of course, be necessary to retain the unique digital identification of the object in the known objects store to enable this object to be identified in the future. However, it would not be necessary to store the actual object in the known objects store.

In another case, the action specified in the condition/action specification 54 might be a nightly backup. In that case, if the object is already in the known objects store 80, then the object has already been backed up and no further processing is required. The object selector 28 can then move on to the next object. This has the enormous benefit of reducing network traffic as well as reducing backup media consumption, as objects are not backed up more than once, and, during a given backup session, are not backed up at all if there have been no changes in the objects since the last backup operation. The benefits of this approach are clear given that the same object may be stored on hundreds or thousands of different network components within the same computer network 20.

In some cases, the conditions specified in condition/action specification 54 may also refer to the specific network component in the object information. For example, in some cases it may be desired to add particular objects to a particular workstation if that workstation does not already include such objects. In this case, whether an object is to be added to this network component is considered by logic submodule 56 at process point 92 in FIG. 7. At process point 92, logic submodule 56 will determine whether the locations specified in field 52c for that object include all of the network components on which the object should be installed. If not, then object processing submodule 60 can add this object to these network components. Of course, the opposite operation may also be conducted. For example, in cases where only a limited number of licenses for a particular program are held, then condition/action specification 54 may well include instructions to delete this particular object from network components 22 that are not authorized to have a copy of that object.

Other actions that could be performed by object processing submodule 60 would include replacing or modifying the object with a more up-to-date object—for example, as in the case where a later version of an existing program has been provided.

After all of the actions specified by condition/action specification 54 have been taken vis-á-vis the particular object, these actions are communicated to object store manager 32 at process point 94 of FIG. 7. Object storage manager 32 then updates the known objects store 80 to reflect any changes to the object before processing returns to object selector 28 to consider the next object.

It should be further understood that various modifications can be made, by those skilled in the art, to the preferred embodiments described and illustrated herein, without departing from the present invention, the scope of which is defined in the appended claims.

1. An object management module for installation in a computer network having a plurality of network components, the plurality of network components being electronically connected for communication therebetween, and having a plurality of objects stored thereon; the object management module comprising
(a) an object selector for locating each object in the plurality of objects;
(b) an object identification means for, for each object in the plurality of objects, determining an associated object identifier from all bytes in the object such that identical objects in the plurality of objects have the same associated object identifier;
(c) an object storage manager for, for each object in the plurality of objects, storing the associated object identifier in an object store;
(d) an object processor for selectably processing each object in the plurality of objects based on information stored in the object store regarding the object.

2. The object management module as defined in claim 1 wherein the object storage manager is further operable, for each object in the plurality of objects, to store an associated location of the object in the computer network, the associated location being stored in an associated location record in the object store in linked relation with the associated object identifier.

3. (canceled)

4. The object management module as defined in claim 1 wherein the object processor comprises a condition/action specification for specifying an action to be performed in relation to a selected object, and a condition to be met before performing the action.

5. The object management module as defined in claim 4 wherein the action comprises installing an object in the plurality of objects on a specified network component, and the condition comprises specifying the associated object identifier and the specified network component.

6. The object management module as defined in claim 4 wherein the action comprises erasing an object in the plurality of objects, and the condition comprises specifying the associated object identifier for the object.

7. The object management module as defined in claim 1 wherein each object in the plurality of objects is a file.

8. The object management module as defined in claim 7 wherein each file is one of an executable file, a configuration file, a temporary file, a database, a data file, a record file, a log file, an image file, a document, a manual, a letter, a fax and a memo.

9. The object management module as defined in claim 1 wherein the plurality of objects comprises a plurality of groups of identical objects, objects in different groups being different from one another.

10. The object management module as defined in claim 1 wherein the object identification means is operable to process each object in the plurality of objects to obtain an associated digital fingerprint as the associated object identifier.

11. The object management module as defined in claim 10 wherein (i) the object selector is further operable to locate new objects stored on the plurality of network components, (ii) the object identification means is operable to determine the associated digital fingerprint of the new object from all of the bytes in the new object; and, (iii) the object store manager is operable to determine whether the associated digital fingerprint is new by checking the object store to determine if the associated unique digital fingerprint is stored there.

12. The object management module as defined in claim 6 wherein the object storage manager is further operable, for each network component in the plurality of network components and for each object stored on the network component, to store an associated network component location of the network component in the computer network in the object store in linked relation with the associated object identifier such that the storage module is searchable, using the associated object identifier, to find the associated network component location of each network component having the object having the associated object identifier.

13. A method of managing a plurality of objects stored on a computer network having a plurality of network components, the method comprising:
(a) for each object in the plurality of objects, determining an associated object identifier using all bytes in the object such that identical objects in the plurality of objects have the same associated object identifier;
(b) for each object in the plurality of objects, storing the associated object identifier in an object store;
(c) selecting a group of identical objects in the plurality of objects;
(d) locating each object in the group of identical objects using the associated object identifier; and,
(e) performing a specified action in relation to the object.

14. The method as defined in claim 13 wherein step (b) further comprises, for each object in the plurality of objects, storing the associated object identifier in an object store if the associated object identifier is not already stored in the object store.

15. The method as defined in claim 14 wherein step (b) further comprises, for each object in the plurality of objects, storing an associated location of the object in the computer network in the storage module in linked relation with the associated object identifier such that the storage module is searchable, using the associated object identifier, to find the associated location for each object having the associated object identifier.

16. (canceled)

17. The method as defined in claim 13 wherein each object in the plurality of objects is a file.

18. The method as defined in claim 17 wherein each file is one of an executable file, a configuration file, a temporary file, a database, a data file, a record file, a log file, an image file, a document, a manual, a letter, a fax and a memo.

19. The method as defined in claim 16 wherein the plurality of objects comprises a plurality of groups of identical objects, objects in different groups being different from one another.

20. The method as defined in claim 13 wherein step (a) comprises processing each object in the plurality of objects to obtain an associated digital fingerprint as the associated object identifier, the associated digital fingerprint being determined from all of the bytes in the object.

21. The method as defined in claim 20 further comprising updating the plurality of objects to include new objects stored on the computer network.

22. The method as defined in claim 21 wherein the step of updating the plurality of objects to include the new objects comprises, for each object stored on the computer network, determining if the object is a new object by (i) determining the associated digital fingerprint; (ii) determining whether the associated digital fingerprint is new by checking whether the digital fingerprint is stored in the object store; and, (iii) if the associated digital fingerprint is new, then saving the associated digital fingerprint in the object store.

23. The method as defined in claim 22 wherein step (b) further comprises, for each network component in the plurality of network components and for each object stored on the network component, storing an associated network component location of the network component in the computer network in the object store in linked relation with the associated object identifier such that the storage module is searchable, using the associated object identifier, to find the associated network components location of each network component having the object having the associated object identifier.

24. A computer program product for use on a computer network having a plurality of network components to manage a plurality of objects stored on the computer network, the computer program product comprising:
a recording medium; and,
means recorded on the recording medium for instructing the computer system to perform the steps of:
(a) for each object in the plurality of objects, determining an associated object identifier using all bytes in the object such that identical objects in the plurality of objects have the same associated object identifier;
(b) for each object in the plurality of objects, storing the associated object identifier in an object store;
(c) selecting a group of identical objects in the plurality of objects;
(d) locating each object in the group of identical objects using the associated object identifier; and,
(e) performing a specified action in relation to the object.

25. The computer program product as defined in claim 24 wherein step (b) further comprises, for each object in the plurality of objects, storing the associated object identifier in an object store if the associated object identifier is not already stored in the object store.

26. The computer program product as defined in claim 25 wherein step (b) further comprises, for each object in the plurality of objects, storing an associated location of the object in the computer network in the storage module in linked relation with the associated object identifier such that the storage module is searchable, using the associated object identifier, to find the associated location for each object having the associated object identifier.

27. (canceled)

28. The computer program product as defined in claim 24 wherein each object in the plurality of objects is a file.

29. The computer program product as defined in claim 28 wherein each file is one of an executable file, a configuration file, a temporary file, a database, a data file, a record file, a log file, an image file, a document, a manual, a letter, a fax and a memo.

30. The computer program product as defined in claim 27 wherein the plurality of objects comprises a plurality of groups of identical objects, objects in different groups being different from one another.

31. The computer program product as defined in claim 24 wherein step (a) comprises processing each object in the plurality of objects to obtain an associated digital fingerprint as the associated object identifier, the associated digital fingerprint being determined from all of the bytes in the object.

32. The computer program product as defined in claim 31 further comprising updating the plurality of objects to include new objects stored on the computer network.

33. The computer program product as defined in claim 32 wherein the step of updating the plurality of objects to include the new objects comprises, for each object stored on the computer network, determining if the object is a new object by (i) determining the associated digital fingerprint; (ii) determining whether the associated digital fingerprint is new by checking whether the digital fingerprint is stored in the object store; and, (iii) if the associated digital fingerprint is new, then saving the associated digital fingerprint in the object store.

34. The computer program product as defined in claim 31 wherein step (b) further comprises, for each network component in the plurality of network components and for each object stored on the network component, storing an associated component location of the network component in the computer network in the object store in linked relation with the associated object identifier such that the storage module is searchable, using the associated object identifier, to find the associated component location of each network component having the object having the associated object identifier.

35. The object management module as defined in claim 1 wherein the object store manager is further operable, for each object in the plurality of objects, to store the object in the object store.

36. The method as defined in claim 13 wherein step (c) further comprises, for each object in the plurality of objects, storing the object in the object store.

37. The method as defined in claim 24 wherein step (c) further comprises, for each object in the plurality of objects, storing the object in the object store.
